(19) United States
(12) Patent Application Publication
(10) Pub. No.: US 2016/0035016 A1
(43) Pub. Date: Feb. 4, 2016

(54) METHOD FOR EXPERIENCING MULTI-DIMENSIONAL CONTENT IN A VIRTUAL REALITY ENVIRONMENT

(71) Applicant: Mary A. Spio, Miami Beach, FL (US)

(72) Inventor: Mary A. Spio, Miami Beach, FL (US)

(21) Appl. No.: 14/817,196

(22) Filed: Aug. 3, 2015

Related U.S. Application Data
(60) Provisional application No. 62/032,046, filed on Aug. 1, 2014.

(51) Int. Cl. G06Q 30/06; G06Q 50/00; G06T 19/00

(52) U.S. Cl. CPC G06Q 30/0643; G06T 19/006; G06Q 50/01

(57) ABSTRACT

A method for experiencing of multi-dimensional content in a virtual reality environment over a communications network is disclosed. The method includes generating a 3D avatar of a consumer based on a consumer's profile, generating a 3D virtual reality graphical environment including the avatar of the consumer, receiving a selection from the consumer of multi-dimensional content for experiencing and a predefined time for playing said multi-dimensional content, transmitting an invitation to invitee consumers to experience the multi-dimensional content, generating a virtual location in the multi-dimensional virtual reality graphical environment for playing said multi-dimensional content at the predetermined time in the virtual location in the multi-dimensional virtual reality graphical environment, for the avatars of the consumer and any invitee consumers present at the location at the predetermined time.

### CROSS-REFERENCE TO RELATED APPLICATIONS

This patent application claims priority to provisional application number 62/032,046 filed Aug. 1, 2014. The subject matter of provisional application number 62/032,046 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of virtual reality, and more specifically, to devices and processes related to participating in virtual reality environments over telecommunications networks.

### BACKGROUND

Computers and the Internet are used for conducting commerce and experiencing entertainment,as well as for experiencing media, for educational purposes and for communicating and socialising with others. In the realm of electronic commerce, the majority of said commerce involves searching for and purchasing products online. With the advent of online advertising and the rapidity with which ads can be delivered and displayed online, there is a plethora of advertising that occurs online while a consumer is engaged in electronic commerce. As a result, today, consumers are overloaded and desensitized to traditional advertising while online Further, the current method of searching for products or content online can be boring, time consuming and tedious for many consumers.

Virtual reality is one method in which people use computers and technology to interact or socialize with others, Virtual reality is a computer-generated simulation of a two or three-dimensional image or environment that can be interacted with by a person using special electronic equipment, such as a helmet with a screen inside or other devices filled with sensors, Today, however, virtual reality content is sparse. Consequently, it can be frustrating for consumers to have to sift through various websites in an effort to find virtual reality events and entertainment. Furthermore, individuals often find the current access to virtual reality environments restrictive because to access the virtual reality environments, a consumer must download software from the Internet to access the environment.

Often, individuals believe that virtual reality environments seem unrealistic, boring and not interesting. Moreover, the avatars, or figures representing people within a virtual reality environment, are unrelated to the actual appearance of a particular person. Because of the unrealistic nature of the avatars and environments, many people do not find virtual reality environments enjoyable.

Therefore, a need exists for improvements over the prior art. There is also a need for methods and systems that make the virtual reality experience more realistic. A need also exists to make virtual reality environments more accessible with more content that consumers find enjoyable. Additionally, there is also a need to more efficiently and more enjoyably search content and purchase items on the Internet.

### SUMMARY

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method for experiencing of multi-dimensional content in a virtual reality environment over a communications network is disclosed. The method includes generating a multi-dimensional avatar of a consumer based on a consumer's profile, generating a multi-dimensional virtual reality graphical environment including the avatar of the consumer, receiving a selection, over the communications network, from the consumer to play or experience multi-dimensional content, wherein the selection includes a unique identifier for said multi-dimensional content and a predefined time for playing said multi-dimensional content, transmitting an invitation, over the communications network, to invitee consumers to experience the multi-dimensional content at the predetermined time, wherein the invitation includes a description of the multi-dimensional content and the predetermined time and wherein the invitee consumers each have an associated multi-dimensional avatar, generating a virtual location in the multi-dimensional virtual reality graphical environment, wherein the location is configured to play said multi-dimensional content, accept the avatar of the consumer, and accept the avatars of the other consumers, and playing said multi-dimensional content at the predetermined time in the virtual location in the multi-dimensional virtual reality graphical environment, for the avatar of the consumer and for the avatar of any invitee consumers present at the location at the predetermined time.

### BRIEF DESCRIPTION OF THE DRAWINGS

The subject matter, which is regarded as the disclosed embodiments, is particularly pointed out and distinctly claimed in the claims at the conclusion of the specification. The foregoing and other features and also the advantages of the disclosed embodiments will be apparent from the following detailed description taken in conjunction with the accompanying drawings. Additionally, the left most digit of a reference number identifies the drawing in which the reference number first appears. The accompanying drawings, which are incorporated in and constitute a part of this disclosure, illustrate various example embodiments. In the drawings:

FIG. 1 is a diagram of an operating environment that supports a method for experiencing of multi-dimensional content in a virtual reality environment over a communications network, according to one embodiment;

FIG. 2 is a flow chart showing the control flow of the process or method for experiencing multi-dimensional content in a virtual reality environment over a communications network, according to an example embodiment;

FIG. 3 is a diagram illustrating the data flow of the process or method for experiencing multi-dimensional content in a virtual reality environment over a communications network, according to an example embodiment;

FIG. 4A-4C are two dimensional representations of the multi-dimensional content that a consumer may experience, according to an example embodiment;

FIG. 5 is an illustration of a three dimensional representation of a surface, according to an example embodiment; and,

FIG. 6 is a block diagram of a system including an example computing device and other computing devices.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosed embodiments. Instead, the proper scope of the disclosed embodiments is defined by the appended claims.

The disclosed embodiments improve over the prior art by providing a more realistic virtual reality experience and a method for experiencing of, interfacing with, and navigating through multi-dimensional content in a virtual reality environment over a communications network. This includes providing more realistic environments and an avatar that more closely resembles a user or consumer affiliated with such avatar. The methods also provide a system for consumers to interact with one another and to experience multi-dimensional content at a predetermined time (such as experiencing a motion picture or concert within the virtual reality environment). The disclosed embodiments also provide more environments that are more accessible with more multi-dimensional content that users find enjoyable.

The method also includes providing a more accessible virtual reality experience by allowing consumers to access the virtual reality environment anywhere with internet access without having to download software. The disclosed embodiments also improve over the prior art by providing a more enjoyable way to search multi-dimensional content, view multi-dimensional content with other consumers, interact with other consumers and purchase items on the internet. This is accomplished by providing more interesting multi-dimensional content for experiencing with interactive audio and visual multi-dimensional content that can be searched by and influenced by the consumer. The method also improves over the prior art by providing a multi-dimensional virtual reality experience, which allows a consumer to be fully immersed in the virtual reality environment.

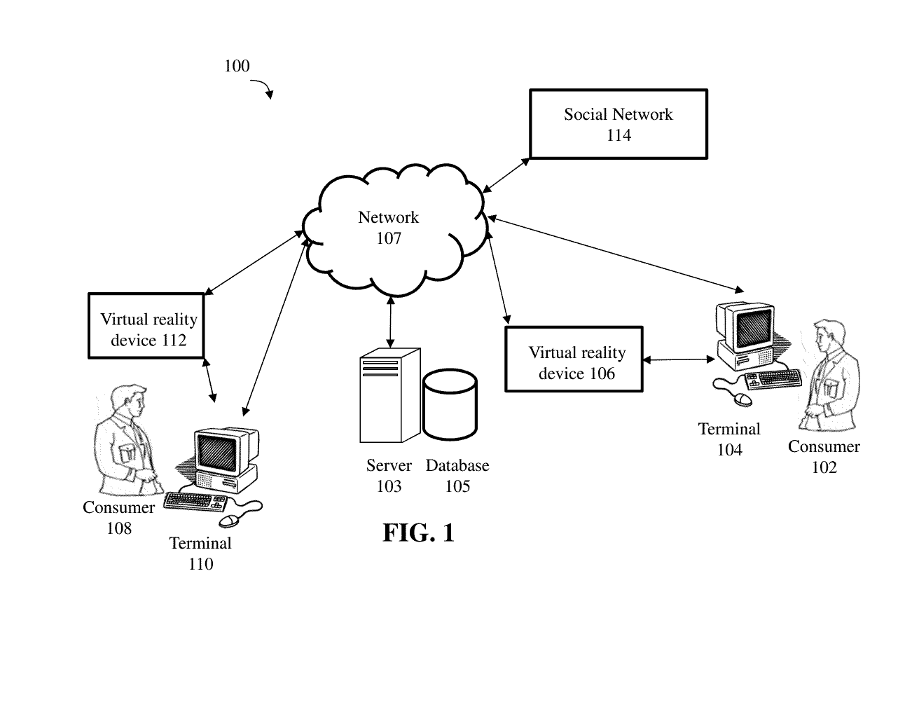

FIG. 1 is a diagram of an operating environment that supports a method for experiencing of, interacting with, and navigating through multi-dimensional content in a virtual reality environment over a communications network, according to one embodiment. In one embodiment, the invention is a method 100 on a server 103 for providing a plurality of virtual reality environments, experiencing multi-dimensional content, and navigating through the virtual reality graphical environment by a plurality of avatars (operated by a plurality of users or consumers), over a communications network 107. The method may include generating a multi-dimensional avatar of a consumer based upon a consumer's profile for each of a plurality of consumers or users 102, 108, via the communication network. An avatar and may be controlled by a physical person, consumer or user 102, 108, by a computing device having artificial intelligence, or any combination of the two. The multi-dimensional avatar may be a three-dimensional or holographic avatar. The avatar may be used by the consumer to navigate through the virtual reality graphical environment using a virtual reality device. Each consumer may also interact other avatars, controlled by other consumers, in the virtual reality graphical environment. Each avatar may comprise a plurality of digital multi-dimensional content associated with images uploaded by a corresponding consumer via the communications network. In other embodiments, the content uploaded may contain biometric cues. In one embodiment, the multi-dimensional avatar may include an image of a consumer's face comprising a two or three-dimensional still image of the consumer's face. In other embodiments, the avatar may include a holographic image corresponding to the consumer or user. In other embodiments, the method may also be adapted to receive audio content. Each consumer profile may contain one or more personal parameters provided by each consumer and storing said consumer profiles in an attached database 105.

The virtual reality graphical environment can be a variety of different settings. For example, the multi-dimensional virtual reality environment may be lounges, meeting places, stores, movie theaters, sporting events, bars, restaurants, shops, etc. The multi-dimensional content may comprise audio and/or video content.

The system is also configured for receiving a selection, over the communications network, from the consumer of playing multi-dimensional content, wherein the selection includes a unique identifier for said multi-dimensional content and a predefined time for playing said multi-dimensional content. The unique identifier may include a key to allow the system to identify the content. For example, in one embodiment, a consumer through an avatar or other user interface or controlling device (such as a hand held controller, mouse, etc.) may select, over the communications network, to experience content such as a live concert, motion picture, or a commercial setting such as a bar or lounge etc.

The system may also be configured to transmit an invitation, over the communications network, to invitee consumers to experience the multi-dimensional content at the predetermined time. The invitation may include a description of the multi-dimensional content and the predetermined time that the content is scheduled to displayed within the virtual reality environment. The invitee consumers each have an associated multi-dimensional avatar. The invitation allows the scheduling of multiple consumers to experience content at the same time. For example, an invitation may be transmitted to multiple consumers or users such that the users, through their associated avatars, can experience a concert, motion picture or attend a social event at the same time.

The system may also be configured for generating a virtual location in the multi-dimensional virtual reality graphical environment. The location may be configured to play the multi-dimensional content and accept the avatar of multiple consumers 104, 108. The multidimensional virtual reality graphical environments are also configured for allowing multiple consumers to interact with one another as well as navigate through the environment.

The system may also be configured to play said content at the predetermined time in the virtual location in the multi-dimensional virtual reality graphical environment, for the avatar of the consumer and for the avatar of any invitee consumers present at the location at the predetermined time.

The system is also configured to display the virtual reality environment and content for presenting on a displaying device at each of a plurality of terminals 104, 108 or virtual reality devices 106, 112 of consumers. The content may include audio multi-dimensional content, visual multi-dimensional content and metadata. While only two consumers, 108, 102 are shown, this is not meant to be a limitation and multiple consumers be use the environment 100.

The system may be in communication with a social network 114, which may be an online social networking service, such as Facebook and Twitter, which provides well known social networking services, such as message delivery, profile creation and browsing, etc. The system also includes transmitting, over the communications network, the data for presenting on the displaying device at each terminal of the plurality of terminals. The system also includes transmitting, over the communications network 107, audio content, visual multi-dimensional content and metadata for presenting on the displaying device at each terminal of the plurality of terminals.

In one embodiment, the displaying device 104, 106, 110, 112 may include a monitor for the consumer to view the virtual environment and a console for such consumer to influence or navigate in the environment. Each displaying device may also include a virtual reality device 106, 112. Each terminal 104, 110 may be integral with or separate from the virtual reality device 106, 112 or by a controlling device associated with the terminals, such as by a mouse or pointer. In other embodiments, a mouse may connected to the terminal may be used. Each consumer may navigate a corresponding avatar through the multi-dimensional virtual reality environment using the virtual reality device. In one embodiment, the virtual reality device may be a consumer virtual reality device such as goggles, a heads up display or other input-output device. In another embodiment, the display device may include the OCULUS RIFT, Samsung Gear VR and other head mounted devices. The virtual reality devices may also include various sensors, detectors and output devices that allow the consumer a more lifelike experience when interacting with other consumer's avatars in the virtual reality environment. In another embodiment, the virtual reality device may be controlled by voice commands.

In other embodiments, each terminal 104, 110 and/or virtual reality device 106, 112 may include a graphical user interface to allow a consumer to make a selection within the environment. In one embodiment, the selection may be made by the consumer using a graphical user interface to input textual commands. In other embodiments, the selection may be made by voice commands. In other embodiments, a hand-held controller may be used to allow for pointer or visual selection. In other embodiments, the selection may be made by the system detecting the focus point of a field of view of a consumer. The field of view of a consumer may be determined by the system when a consumer maintains a virtual reality device in one location for a predetermined period of time. For example, if a consumer uses a virtual reality device to focus on one position for a predetermined time, then the system may determine that the consumer is focusing on a particular point within the field of view of the consumer, and thereby cause the system to make a selection. In other embodiments, the step of receiving a selection comprises, receiving textual inputs from the consumer via a graphical user interface, or detecting a mouse click initiated by the consumer on a virtual item in the multi-dimensional virtual reality graphical environment.

Each terminal 104, may comprise any computing devices, such as integrated circuits, printed circuit boards, processors, ASICs, PCBs, cellular telephones, smart phones, tablet computers, desktop computers, laptops, and game consoles, for example. Terminals 104, 110 and virtual reality devices 106, 112 may be connected either wirelessly or in a wired or fiber optic form to the communications network 107. The communications network may be one or more packet switched networks, such as the Internet, or any local area networks, wide area networks, enterprise private networks, cellular networks, phone networks, mobile communications networks, or any combination of the above. In one embodiment, the terminals 104, 110 is a programmable logic controller or PLC.

Server 103 includes a software engine that delivers applications, data, program code and other information to terminals 110,104 and virtual reality devices 106, 112. The software engine of server 103 may perform other processes such as transferring multimedia data in a stream of packets that are interpreted and rendered by a software application as the packets arrive. FIG. 1 further shows that server 103 includes a database or repository 105, which may be a relational database comprising a Structured Query Language (SQL) database stored in a SQL server or a database that adheres to the noSQL paradigm. Terminals 104,110, and virtual reality devices 106, 112 may also each include databases. The database 103 may serve data from virtual reality devices 106, 112, as well as related information, used by server 103 and terminals 104, 110 during the course of operation of the invention.

Terminals 104, 110, virtual reality devices 106, 112 and server 103 may each include program logic comprising computer source code, scripting language code or interpreted language code that perform various functions of the present invention. It should be noted that although FIG. 1 shows only two terminals 104, 110, and one server 103, the system of the present invention supports any number of terminals or computing devices connected via network 107. Also note that although server 103 is shown as a single and independent entity, in one embodiment, server 103 and its functionality can be realized in a centralized fashion in one computer system or in a distributed fashion wherein different elements are spread across several interconnected computer systems.

Various types of data may be stored in the database 105 of the server 103. For example, the database may store one or more consumer profile for each of the plurality of consumers. As mentioned above, each consumer profile may contain one or more personal parameters provided by each consumer. Such personal parameters may include age, geographic location, last login time, sex, personal preferences, and other data associated with the demographics of each consumer. The database 105 may also include environment data associated with the virtual reality environment for presenting on each displaying device. This environment data may include audio content, visual multi-dimensional content as well as metadata. This environment data may further include a plurality of interactive audio and visual multi-dimensional content that can be searched and influenced by the consumer. The environment may also be configured for forced feedback or the simulation of physical attributes such as weight in computer gaming and virtual reality, allowing the user to interact directly with virtual objects using touch.

The environment may also include metadata, which is a set of data that gives information about the audio and visual multi-dimensional content. The system allows a consumer to influence or select visual multi-dimensional content within the environment. For example, if a consumer is navigating an avatar through the environment and sees a certain item within the environment that the consumer would like to buy, the consumer can select or touch the item for purchase. The item within the environment contains metadata, such as the price, maker, size etc. about the item that will be displayed in a visual format once selected.

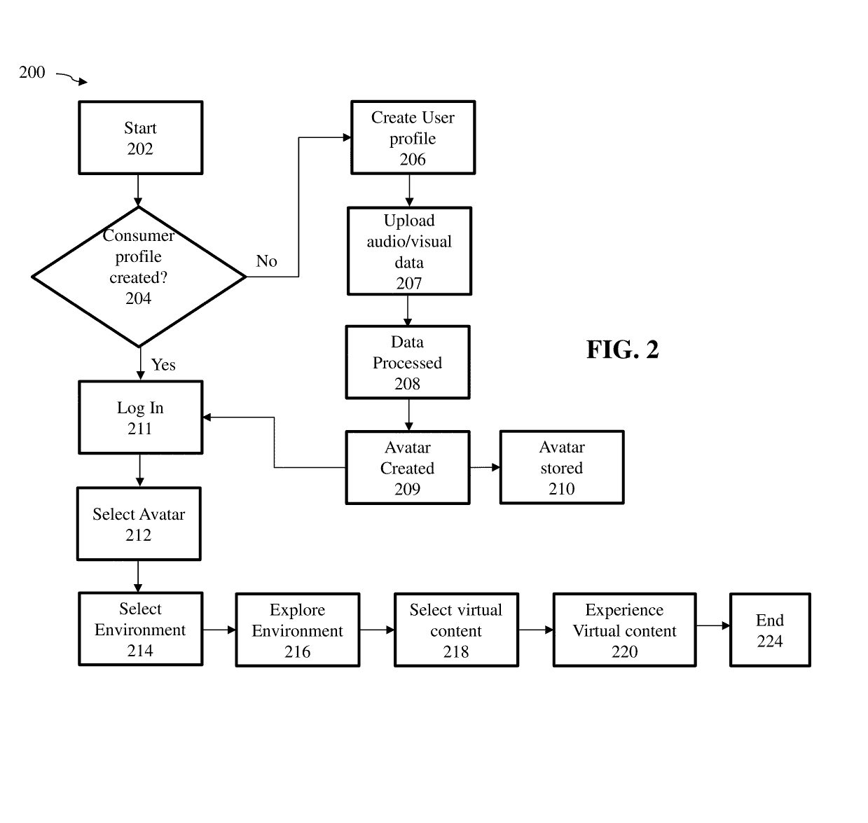

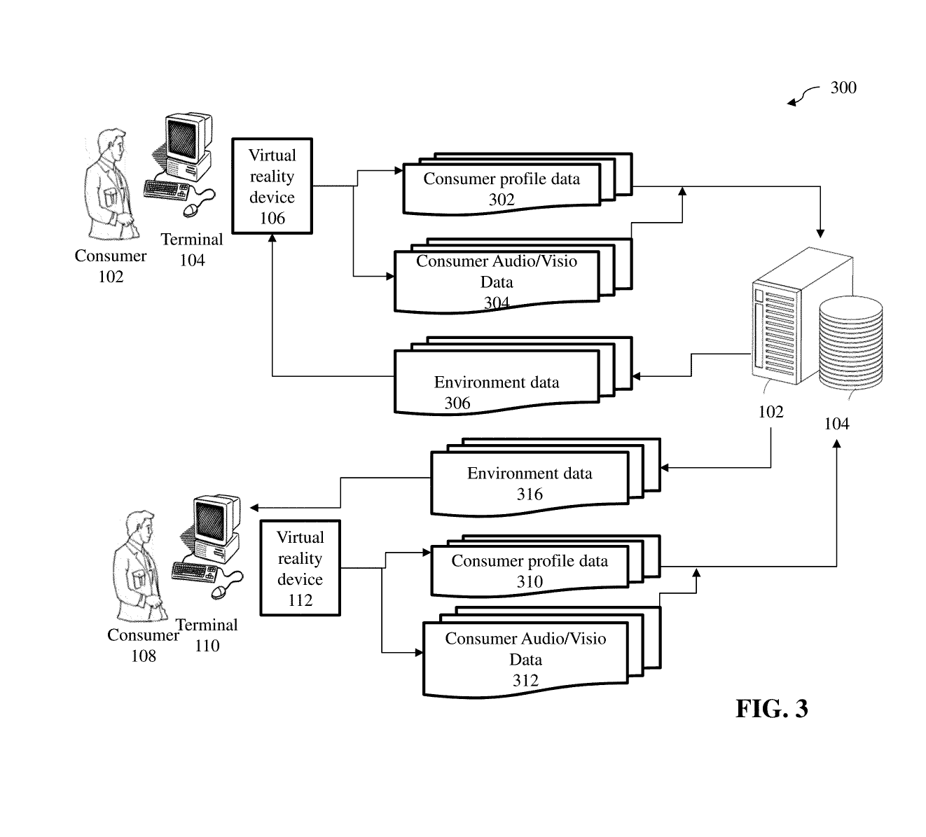

FIGS. 2 and 3 will be discussed together. FIG. 2 is a flow chart showing the control flow 200 of the process or method for experiencing multi-dimensional content in a virtual reality environment over a communications network, according to an example embodiment. FIG. 3 is a diagram illustrating the data flow 300 of the process or method for experiencing multi-dimensional content in a virtual reality environment over a communications network, according to an example embodiment.

Process 200 describes the general steps that occur when a consumer experiences, interacts or participates, and navigates within the virtual reality environment. In step 202, a consumer 102, 108 interfaces with the terminal that such consumer intends to use to interface with the environment. This may include putting on a virtual reality device and/or accessing a website page. In step 204, if a consumer already has a consumer profile created, the consumer will login, step 211, and then in step 212 select the avatar that corresponds to the consumer's profile.

If a consumer profile has not been created, in step 206, the consumer creates a consumer profile. The consumer profile can include one or more personal parameters or consumer profile data 302, 310 provided by the consumer. These personal parameters may include the geographic location, age, sex and other demographics or information personal to the consumer. The consumer may also enter consumer or parameters about herself into a user interface, such as answering questions about height, weight, hair color, skin color, build, frame, size of various body parts, clothing preferences, measurements, etc. These personal parameters may also be obtained through interface with various social networks such as Facebook, Instagram, Twitter, etc. and may be imported from social networks 114. These personal parameters may be used by advertisers and promoters to display audio and visual multi-dimensional content relevant to the consumer's preferences.

In step 207, the consumer may upload an image or photograph or other audio and visual data 304, 312 of the consumers. The consumer may capture an upload audio and visual content using a capturing device from the terminals 104 or 110. In another embodiment, a camera, three dimensional scanner, LIDAR scanner, laser range finder, three dimensional imager, body scanner or other type of device is used to collect visual/measurement data about the consumer and his body, similar to the data that may be entered by the consumer. In another embodiment, the data about consumer is entered/collected using a combination of any of the embodiments above. The image may be of a consumer's face or body and may comprise a two or three-dimensional image of the consumer's face. Other data may also be provided by the consumer so that the avatar closely resembles the features or characteristics of the consumer. After uploading the image and other audio and visual data, in step 208, the data is processed.

In step 208, the data collected in step 207 is processed so as to place it in a form or format for creating a user avatar in step 209, wherein the avatar may comprise a three dimensional graphical representation of one or more surfaces, wherein the surface may depict varying colors and patterns and wherein the surface may have a thickness. Further, the surface of the avatar may move and may have elasticity characteristics. In step 210, the data about the avatar is stored in a record that is associated with a user record for consumer 102, 108. In addition, electronic payment information may be stored in a record that is associated with a user record for consumer. The avatar is created based upon the data received and processed by the system so that the avatar closely resembles the visual content captured and/or uploaded by the consumer. This step allows the consumer to have an avatar that closely resembles the consumer in real life. In step 210, each avatar and profile data 302, 304, 310, 312 can be stored in the attached database.

Once a user profile and avatar is created, then a user may move to step 211 to log in and in step 212, the consumer selects the avatar that the consumer intends to experience and navigate the multidimensional virtual reality environment with. In step 214, the consumer can use a user interface, such as a graphical user interface, controller, or other virtual reality device to select the multidimensional content that the consumer desires to experience and that the consumer desires the system to play.

In one embodiment, as mentioned above, the selection may be received by textual inputs from the consumer via a graphical user interface. In other embodiments, as mentioned above, the selection may be received through voice recognition/commands, or a remote hand-held controller. The selection may include a unique identifier for said multi-dimensional content and a predefined time for playing said multi-dimensional content. In step 214, consumers can use the virtual reality device 106, 112, terminal 104, 110 to select the virtual environment the user intends to navigate or experience.

The system may also transmit multiple invitations, over the communications network, to invitee consumers to experience the multi-dimensional content at a predetermined time. The invitation may include a description of the multi-dimensional content and the predetermined time the content is to be displayed. For example the system may send invitations to consumers to attend a live concert, watch a movie, socialize in a lounge or other gathering place or attend a networking event. In one embodiment, the invitation may be an email or text message. In other embodiments, the invitation may be sent after the consumer selects environment.

Next, the system will generate a multi-dimensional virtual reality graphical environment including the avatar of the consumer and transmit 306, 316 so that other consumers can view the avatars and multidimensional content. As mentioned above, the virtual reality environment may include various types of settings including museums, nature, national parks, lounges, bars or other social settings and areas.

In step 216, the consumer explores, navigates and experiences the environment that the consumer has selected. The system is also configured to generate and transmit a virtual reality location 306, 316 that is configured to play the multidimensional content selected by the consumer as well as to accept the avatars of multiple consumers and allow the avatars to navigate and interact with each other.

The virtual reality graphical environment may also include live streaming of sporting events, concerts, live meetings etc. The live streaming of such events allows the consumer to socialize, via avatars, with other consumers in remote locations while watching live events streaming in the virtual reality environment. The virtual reality graphical environment includes multi-dimensional content that employs one or more limitations of Newtonian physics. This allows for a more realistic look and feel of the environment. The environment may also include audio and visual multi-dimensional content that interface with a plurality of promotional and advertising materials from one or more businesses. For example, a business may include a live broadcasting feed at a virtual environment to a painting or photograph in an art gallery. If the consumer selects the painting or photograph, by touch or otherwise, the metadata associated with such painting is accessed and displayed in a visual format within the environment. In this example, interfaces allowing the consumer to purchase the painting may be included. Further, in step 206, a consumer may provide credit card or payment information when creating the consumer profile.

Optionally, in step 218, while exploring the virtual reality environment, the consumer may also receive an invitation to experience additional multi-dimensional content. The invitation may also include an audiovisual description of the content as well as the predetermined time where the consumer and associated avatar experience the content played.

For example, the virtual reality environment may include a movie theater having movie posters along the wall of a hallway. As the consumer's avatar walks down the hall, the consumer can easily view multiple movie titles in a natural way. In step 218, the consumer may select (according to the embodiments described above) a movie title using the avatar, graphical user interface, user interface, hand-held controller, voice control etc. After selecting the movie title, the system will then generate a second virtual location to play the multidimensional content selected by the avatar so that the consumers, through their avatars can as in step 220 can view the content. The content may displayed on a display screen within the virtual reality environment. The second virtual reality location will be configured to play the multidimensional content, or movie, and accept avatars of multiple users. As a result, the second virtual reality location will allow consumers to interact through their avatars at the same time experience the multi-dimensional content or movie, concert etc.

Additionally, the consumer can filter other consumers appearing within the virtual reality environments based upon the parameters associated with the consumer's profile. For example, if a consumer only desires ones to see avatars associated with other consumers having a certain geographic proximity of the consumer in real life, the consumer can specify such desired condition limiting the avatars within the virtual reality environment.

In step, 224, the consumer can exit the environment by logging of, tuning of the virtual reality device, leaving a website etc. A consumer may control his or her avatar, such as commanding her to walk around a virtual store, preview virtual goods and make purchases online The avatar may move, walk, act and talk like the consumer, which it represents. The avatar may touch, hold, move, and otherwise inspect the virtual goods or other items that are provided by the virtual reality environment.

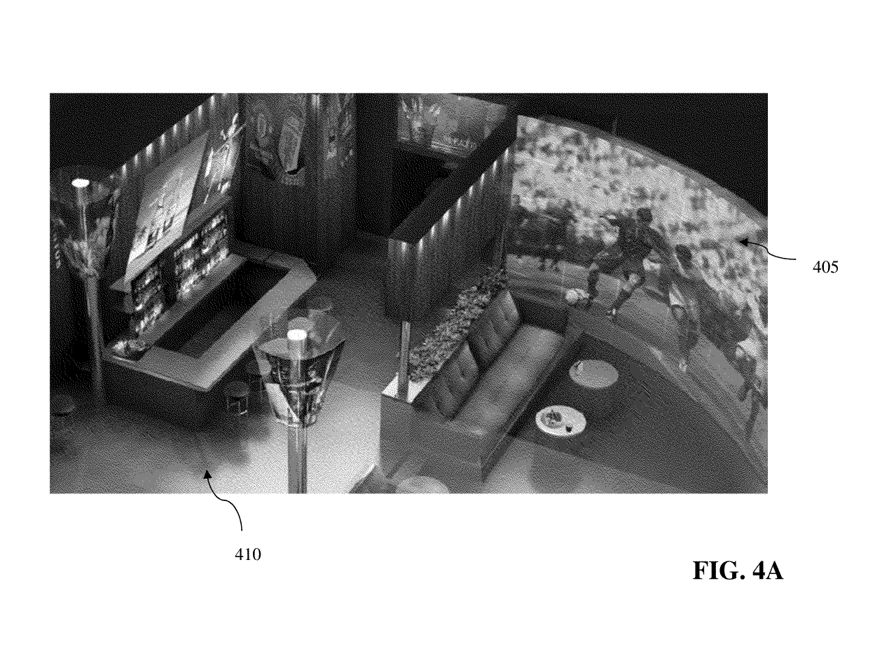

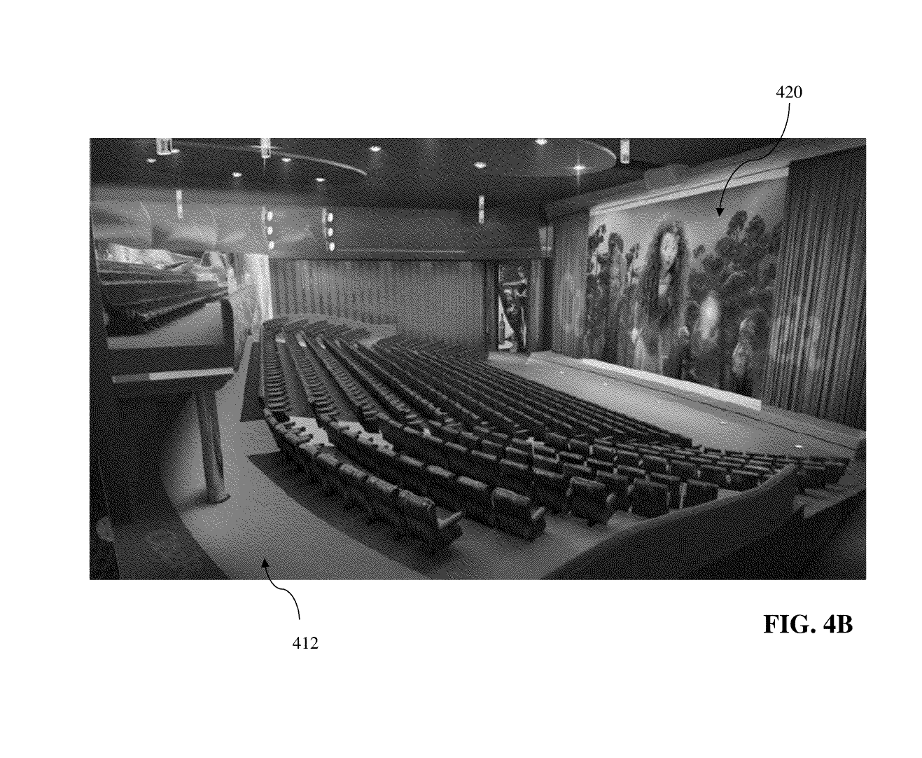

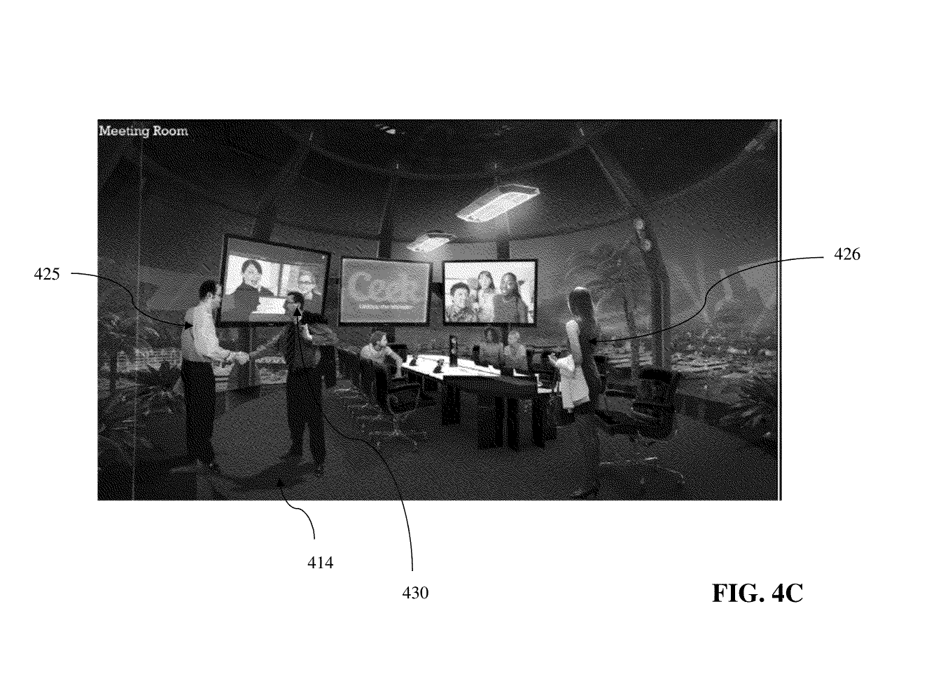

FIGS. 4A-4C are two dimensional representations of the multi-dimensional virtual reality content that a consumer may experience, according to an example embodiment. In one embodiment, the content may displayed on a web browser on terminals 102, 110. In other embodiments, the content may be displayed and viewed by the consumer using virtual reality devices. FIGS. 4A-4C illustrate that content may include multidimensional virtual reality environments, 410, 412, 414. Within the virtual reality environment, avatars 425, 430 of multiple consumers may interact with one another within the environments based upon the consumer's commands. The environments may comprise a three dimensional graphical representation of one or more surfaces, wherein the surface may depict varying colors and patterns and wherein the surface may have a thickness. Further, the surface of the virtual components within the environment may move and may have elasticity characteristics. For example, item of clothing 426, whether it is size, elasticity, color, etc., correlates in size to an actual item of clothing that a consumer wears based upon the consumer profile data and consumer audio and visual data.

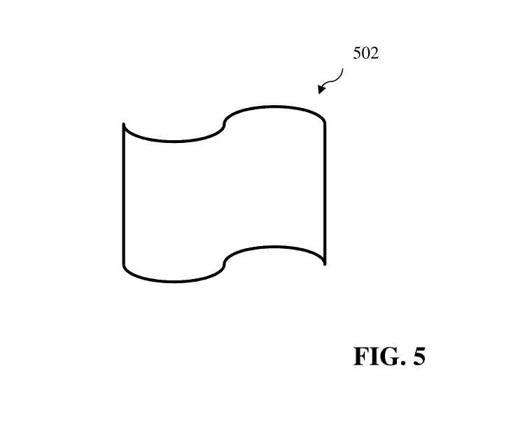

FIG. 5 is an illustration of a three dimensional representation of a surface 502, according to an example embodiment. In three dimensional computer graphics, three dimensional modeling is the process of developing a mathematical representation of any three-dimensional surface of object using software. The product is called a three dimensional model, such as surface 502 in FIG. 5. The surface can also be a holographic surface. It can be displayed as a two-dimensional image through a process called three dimensional rendering or used in a computer simulation of physical phenomena. In this manner, avatars 425, 430 and environments, such as 410, 412, 414 may graphically represented and rendered. Three dimensional models represent a three dimensional object using a collection of points in three dimensional space, connected by various geometric entities such as triangles, lines, curved surfaces, etc. Being a collection of data (points and other information), three dimensional models can be created by hand, algorithmically (procedural modeling), or scanned.

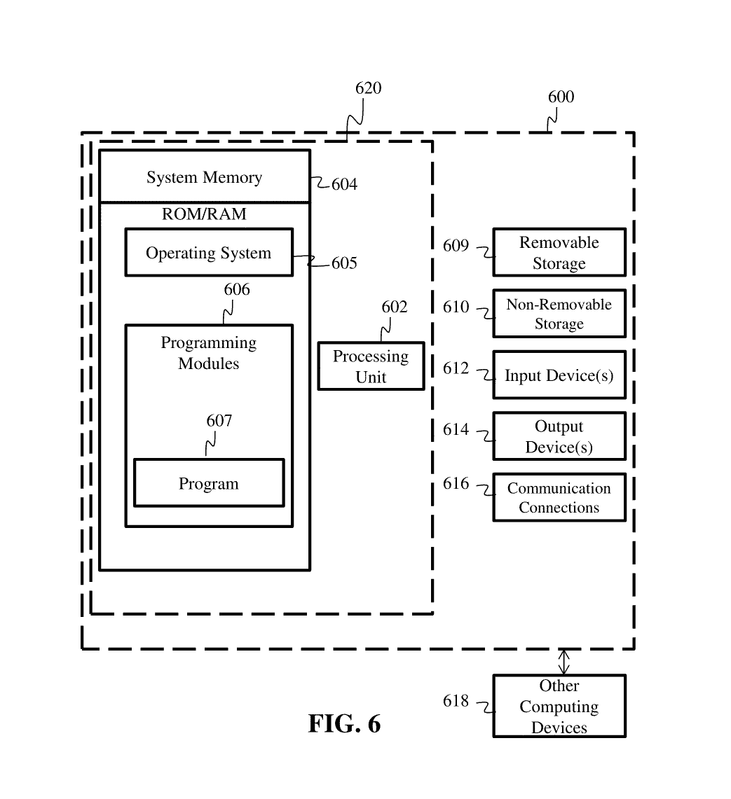

FIG. 6 is a block diagram of a system including an example computing device that be used as terminals 104, 110 and virtual reality devices 106, 112. Consistent with the embodiments described herein, the aforementioned actions may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 300 may comprise an operating environment for devices and systems, as described above. Process 300 may operate in other environments and are not limited to computing device 300.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, one or more programming modules 606. Operating system 605, for example, may be suitable for controlling computing device 600's operation. In one embodiment, programming modules 606 may include, for example, a virtual reality program module 607. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. virtual reality program module 607) may perform processes including, for example, one or more of method 300's, 400's or method 500's stages as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for experiencing multi-dimensional content in a virtual reality environment over a communications network, comprising:
generating a multi-dimensional avatar of a consumer based on a consumer's profile;
generating a multi-dimensional virtual reality graphical environment including the avatar of the consumer;
receiving a selection, over the communications network, from the consumer of multi-dimensional content for experiencing, wherein the selection includes a unique identifier for said multi-dimensional content and a predefined time for playing said multi-dimensional content;
transmitting an invitation, over the communications network, to invitee consumers to experience the multi-dimensional content at the predetermined time, wherein the invitation includes a description of the multi-dimensional content and the predetermined time and wherein the invitee consumers each have an associated multi-dimensional avatar;
generating a virtual location in the multi-dimensional virtual reality graphical environment, wherein the location is configured to play said multi-dimensional content, accept the avatar of the consumer, and accept the avatars of the other consumers; and
playing said multi-dimensional content at the predetermined time in the virtual location in the multi-dimensional virtual reality graphical environment, for the avatar of the consumer and for the avatar of any invitee consumers present at the location at the predetermined time.

2. The method of claim 1, wherein a multi-dimensional avatar includes visual content associated with images uploaded by a corresponding user.

3. The method of claim 1, wherein the step of receiving a selection comprises receiving textual inputs from the consumer via a graphical user interface.

4. The method of claim 1, wherein the step of receiving a selection comprises detecting a mouse click initiated by the consumer on a virtual item in the multi-dimensional virtual reality graphical environment.

5. The method of claim 1, wherein multi-dimensional content comprises audio and/or video.

6. A non-transitory computer-readable storage medium storing executable instructions, which, when executed by a computing device, cause the computing device to perform a method for experiencing of multi-dimensional content in a virtual reality environment over a communications network, the method comprising:
generating a multi-dimensional avatar of a consumer based on a consumer's profile;
generating a multi-dimensional virtual reality graphical environment including the avatar of the consumer;
receiving a selection, over the communications network, from the consumer of multi-dimensional content for experiencing, wherein the selection includes a unique identifier for said multi-dimensional content and a predefined time for playing said multi-dimensional content;
transmitting an invitation, over the communications network, to invitee consumers to experience the multi-dimensional content at the predetermined time, wherein the invitation includes a description of the multi-dimensional content and the predetermined time and wherein the invitee consumers each have an associated multi-dimensional avatar;
generating a virtual location in the multi-dimensional virtual reality graphical environment, wherein the location is configured to play said multi-dimensional content, accept the avatar of the consumer, and accept the avatars of the other consumers; and
playing said multi-dimensional content at the predetermined time in the virtual location in the multi-dimensional virtual reality graphical environment, for the avatar of the consumer and for the avatar of any invitee consumers present at the location at the predetermined time.

7. The method of claim 6, wherein a multi-dimensional avatar includes an image of a consumer's face comprising a two dimensional still image of the consumer's face.

8. The method of claim 6, wherein the step of receiving a selection comprises receiving textual inputs from the consumer via a graphical user interface.

9. The method of claim 6, wherein the step of receiving a selection comprises detecting a mouse click initiated by the consumer on a virtual item in the multi-dimensional virtual reality graphical environment.

10. The method of claim 6, wherein multi-dimensional content comprises audio and/or video.

11. A computer system for providing a method for experiencing of multi-dimensional content in a virtual reality environment over a communications network, the system comprising:
a database for storing multi-dimensional content and profiles for consumers;
a memory storage;
a network connection device communicably coupled with the communications network; and
a processing unit coupled to the memory storage, the database and the network connection device, wherein the processing unit is operative for:
generating a multi-dimensional avatar of a consumer based on a consumer's profile;
generating a multi-dimensional virtual reality graphical environment including the avatar of the consumer;
receiving a selection, over the communications network, from the consumer of multi-dimensional content for experiencing from the database, wherein the selection includes a unique identifier for said multi-dimensional content and a predefined time for playing said multi-dimensional content;
transmitting an invitation, over the communications network, to invitee consumers to experience the multi-dimensional content at the predetermined time, wherein the invitation includes a description of the multi-dimensional content and the predetermined time and wherein the invitee consumers each have an associated multi-dimensional avatar;
generating a virtual location in the multi-dimensional virtual reality graphical environment, wherein the location is configured to play said multi-dimensional content, accept the avatar of the consumer, and accept the avatars of the other consumers; and
playing said multi-dimensional content at the predetermined time in the virtual location in the multi-dimensional virtual reality graphical environment, for the avatar of the consumer and for the avatar of any invitee consumers present at the location at the predetermined time.

12. The method of claim 11, wherein a multi-dimensional avatar includes an image of a consumer's face comprising a two dimensional still image of the consumer's face.

13. The method of claim 11, wherein the step of receiving a selection comprises receiving textual inputs from the consumer via a graphical user interface.

14. The method of claim 11, wherein the step of receiving a selection comprises detecting a mouse click initiated by the consumer on a virtual item in the multi-dimensional virtual reality graphical environment.

15. The method of claim 11, wherein the step of receiving a selection comprises detecting a focus point of a field of view of a consumer.

16. The method of claim 11, wherein multi-dimensional content comprises audio and/or video.

17. The method of claim 11, wherein the step of receiving a selection comprises receiving inputs from the consumer via a user interface.

18. The method of claim 11, wherein each consumer navigates and interacts with a corresponding avatar though the virtual reality environment using a virtual reality device.
